(19) United States
(12) Patent Application Publication
(10) Pub. No.: US 2011/0149335 A1
(43) Pub. Date: Jun. 23, 2011

(54) PRINTING A PLURALITY OF ELECTRONIC DOCUMENTS ON A COMPUTER PRINTER, WHERE THE PRINTER IS LOGICALLY COUPLED TO A PLURALITY OF COMPUTER SYSTEMS

(75) Inventors: Jeffrey William Nichols, San Jose, CA (US); Jan Hendrik Pieper, San Jose, CA (US)

(73) Assignee: International Business Machines Corporation, Armonk, NY (US)

(21) Appl. No.: 12/641,259

(22) Filed: Dec. 17, 2009

(51) Int. Cl. G06F 3/12

(52) U.S. Cl. 358/1.15

(57) ABSTRACT

The present invention provides a processor-implemented method and system of printing a plurality of electronic documents on a computer printer, where the printer is logically coupled to a plurality of computer systems. In an exemplary embodiment, the method and system include (1) bundling requests for printing a set of the documents from at least one user of at least one of the computer systems, where the bundling includes (a) delaying each of the requests by a certain amount of time and (b) reordering a print queue so that the documents from the user form a contiguous set of documents from the user, (2) outputting one cover sheet from the printer for the contiguous set, and (3) printing the contiguous set on the printer.

### FIELD OF THE INVENTION

The present invention relates to computer systems, and particularly relates to a processor-implemented method and system of printing a plurality of electronic documents on a computer printer, where the printer is logically coupled to a plurality of computer systems.

### BACKGROUND OF THE INVENTION

A typical company may share a computer printer among a set of its employees (e.g., over a computer network). The printer typically prints a cover sheet for each print job in order to identify the owner of the print job and to allow sorting or delivery of the printed pages to the right person. Unfortunately, such cover sheets are usually discarded once the print job has been picked up, leading to significant waste of paper.

### PRIOR ART SYSTEMS

One prior art system, described in U.S. Pat. No. 5,316,279, discusses outputting cover sheets for print jobs from a computer printer. Referring to FIGS. 1A and 1B, the prior art system prints a cover sheet for each print job that is sent to the printer and/or a print queue of the printer. However, this prior art system fails to teach conserving paper when printing such cover sheets.

Referring to FIG. 1A, when a print queue 120 receives a request 112 from a user A to print an electronic document A1, a request 114 from a user B to print an electronic document B, and a request 116 from user A to print an electronic document A2, in that order, print queue 120 outputs a cover sheet 130 (a first cover sheet for user A), a document 131 (document A1), a cover sheet 133 (a cover sheet for user B), document 134 (document B), a cover sheet 136 (a second cover sheet for user A), and a document 137 (document A2), in that order. Thus, the prior art system would print two cover sheets for user A.

Referring to FIG. 1B, when a printer 150 receives a request 142 from a user A to print an electronic document A1, a request 144 from a user B to print an electronic document B), and a request 146 from user A to print an electronic document A2, in that order, printer 150 outputs a cover sheet 160 (a first cover sheet for user A), a document 161 (document A1), a cover sheet 163 (a cover sheet for user B), document 164 (document B), a cover sheet 166 (a second cover sheet for user A), and a document 167 (document A2), in that order. Thus, the prior art system would print two cover sheets for user A.

Another prior art system, described in U.S. Patent Application Publication No. 20040156064, discussed optimizes printing on shared printers to output documents as fast as possible using multiple print engines. However, this prior art system also fails to teach conserving paper when printing such cover sheets.

Another prior art system (from FinePrint Software, LLC) provides a client-side software solution that allows users to manage print jobs after printing (e.g., reviewing the print job, deleting pages, shrinking multiple pages into one page, merging print jobs). This prior art system merges multiple pages into one. However, the prior art system requires significant manual effort by the user.

Therefore, a processor-implemented method and system of printing a plurality of electronic documents on a computer printer, where the printer is logically coupled to a plurality of computer systems, is needed.

### SUMMARY OF THE INVENTION

The present invention provides a processor-implemented method and system of printing a plurality of electronic documents on a computer printer, where the printer is logically coupled to a plurality of computer systems. In an exemplary embodiment, the method and system include (1) bundling requests for printing a set of the documents from at least one user of at least one of the computer systems, where the bundling includes (a) delaying each of the requests by a certain amount of time and (b) reordering a print queue so that the documents from the user form a contiguous set of documents from the user, (2) outputting one cover sheet from the printer for the contiguous set, and (3) printing the contiguous set on the printer.

In an exemplary embodiment, the bundling further includes reordering the print queue of the printer so that the documents from the user form the contiguous set of documents from the user. In an exemplary embodiment, the bundling further includes reordering the print queue of a computer server, where the computer server is logically coupled to the printer, so that the documents from the user form the contiguous set of documents from the user. In an exemplary embodiment, the bundling further includes reordering the print queue of a client computer system, where the client computer system is logically coupled to the printer, so that the documents from the user form the contiguous set of documents from the user.

In an exemplary embodiment, the method and system include, if a request is received to print a set of the documents from at least one user, a present user, of at least one of the computer systems, (a) printing a first document from the set of documents on the printer, (b) if the next request for printing on the printer is from the present user, foregoing printing a cover sheet for the present user on the printer, and (c) if the next request for printing on the printer is from another user, a subsequent user, of at least one of the computer systems, outputting a cover sheet for the present user on the printer.

In an exemplary embodiment, the foregoing includes having the foregoing performed by the printer. In an exemplary embodiment, the foregoing includes having the foregoing performed by a computer server, where the computer server is logically coupled to the printer.

In an exemplary embodiment, the outputting includes, if the printer receives an indication that an output tray of the printer is empty, foregoing printing a cover sheet for the present user on the printer. In an exemplary embodiment, the foregoing includes having the foregoing performed by the printer. In an exemplary embodiment, the foregoing includes having the foregoing performed by a computer server, where the computer server is logically coupled to the printer.

In an exemplary embodiment, the method and system include, if a particular one of the documents from at least one user of at least one of the computer systems contains an odd number of pages, printing information of the cover sheet for the user on the back of the last page of the particular one of the documents. In an exemplary embodiment, the method and system include, for each of the documents, outputting a blank sheet before printing the document on the printer.

The present invention also provides a computer program product usable with a programmable computer having readable program code embodied therein of printing a plurality of electronic documents on a computer printer, where the printer is logically coupled to a plurality of computer systems. In an exemplary embodiment, the computer program product includes (1) computer readable code for bundling requests for printing a set of the documents from at least one user of at least one of the computer systems, wherein the computer readable code for bundling comprises (a) computer readable code for delaying each of the requests by a certain amount of time and (b) computer readable code for reordering a print queue so that the documents from the user form a contiguous set of documents from the user, (2) computer readable code for outputting one cover sheet from the printer for the contiguous set, and (3) computer readable code for printing the contiguous set on the printer.

In an exemplary embodiment, the computer readable code for bundling further includes computer readable code for reordering the print queue of the printer so that the documents from the user form the contiguous set of documents from the user. In an exemplary embodiment, the computer readable code for bundling further includes computer readable code for reordering the print queue of a computer server, where the computer server is logically coupled to the printer, so that the documents from the user form the contiguous set of documents from the user. In an exemplary embodiment, the computer readable code for bundling further includes computer readable code for reordering the print queue of a client computer system, where the client computer system is logically coupled to the printer, so that the documents from the user form the contiguous set of documents from the user.

### THE FIGURES

FIG. 1A is a diagram of a prior art technique.

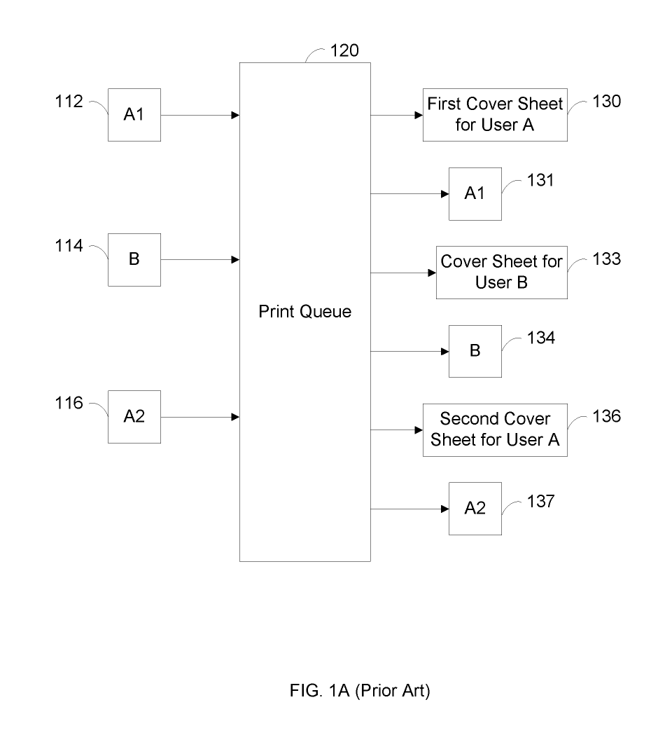

FIG. 1B is a diagram of a prior art technique.

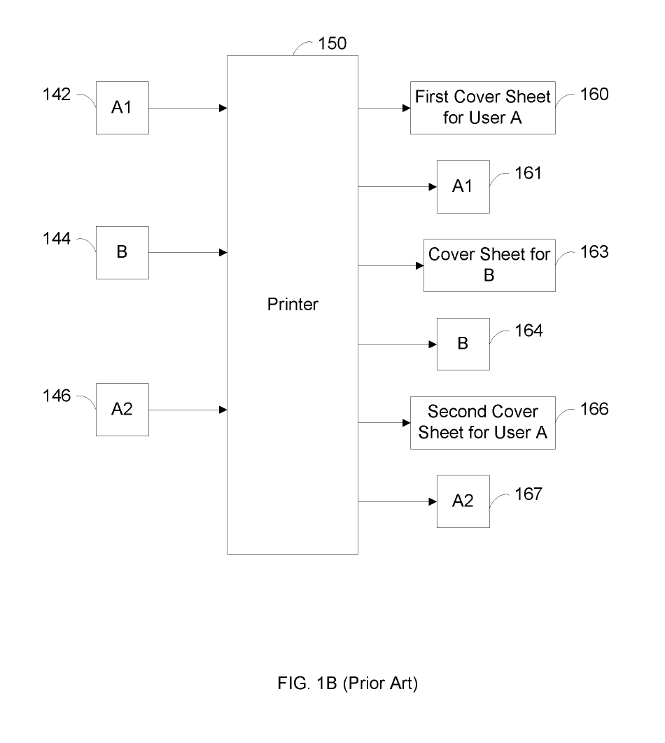

FIG. 2A is a flowchart in accordance with an exemplary embodiment of the present invention.

FIG. 2B is a diagram in accordance with an exemplary embodiment of the present invention.

FIG. 3A is a flowchart of the bundling step in accordance with an exemplary embodiment of the present invention.

FIG. 3B is a flowchart of the bundling step in accordance with an exemplary embodiment of the present invention.

FIG. 3C is a flowchart of the bundling step in accordance with an exemplary embodiment of the present invention.

FIG. 4A is a flowchart in accordance with an exemplary embodiment of the present invention.

FIG. 4B is a diagram in accordance with an exemplary embodiment of the present invention.

FIG. 5A is a flowchart of the foregoing step in accordance with an exemplary embodiment of the present invention.

FIG. 5B is a flowchart of the foregoing step in accordance with an exemplary embodiment of the present invention.

FIG. 6 is a flowchart of the outputting step in accordance with an exemplary embodiment of the present invention.

FIG. 7A is a flowchart of the foregoing step in accordance with an exemplary embodiment of the present invention.

FIG. 7B is a flowchart of the foregoing step in accordance with an exemplary embodiment of the present invention.

FIG. 8A is a flowchart in accordance with an exemplary embodiment of the present invention.

FIG. 8B is a diagram in accordance with an exemplary embodiment of the present invention.

### DETAILED DESCRIPTION OF THE INVENTION

The present invention provides a processor-implemented method and system of printing a plurality of electronic documents on a computer printer, where the printer is logically coupled to a plurality of computer systems. In an exemplary embodiment, the method and system include (1) bundling requests for printing a set of the documents from at least one user of at least one of the computer systems, where the bundling includes (a) delaying each of the requests by a certain amount of time and (b) reordering a print queue so that the documents from the user form a contiguous set of documents from the user, (2) outputting one cover sheet from the printer for the contiguous set, and (3) printing the contiguous set on the printer. In an exemplary embodiment, the method and system include, if a request is received to print a set of the documents from at least one user, a present user, of at least one of the computer systems, (a) printing a first document from the set of documents on the printer, (b) if the next request for printing on the printer is from the present user, foregoing printing a cover sheet for the present user on the printer, and (c) if the next request for printing on the printer is from another user, a subsequent user, of at least one of the computer systems, outputting a cover sheet for the present user on the printer.

In an exemplary embodiment, the method and system include, if a particular one of the documents from at least one user of at least one of the computer systems contains an odd number of pages, printing information of the cover sheet for the user on the back of the last page of the particular one of the documents. In an exemplary embodiment, the method and system include, for each of the documents, outputting a blank sheet before printing the document on the printer.

In an exemplary embodiment, the user is human being. In an exemplary embodiment, the user is a computer system. In an exemplary embodiment, the user is a computer software application.

### Delayed Printing

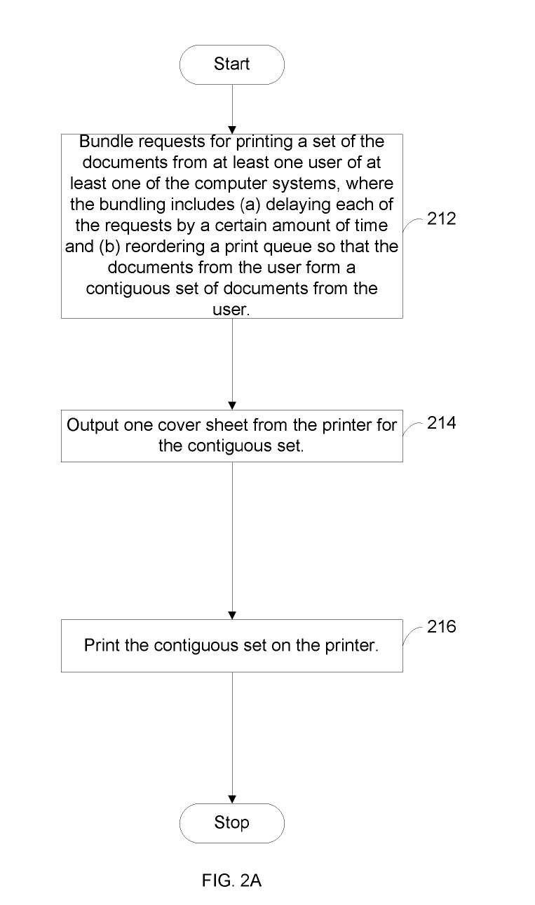

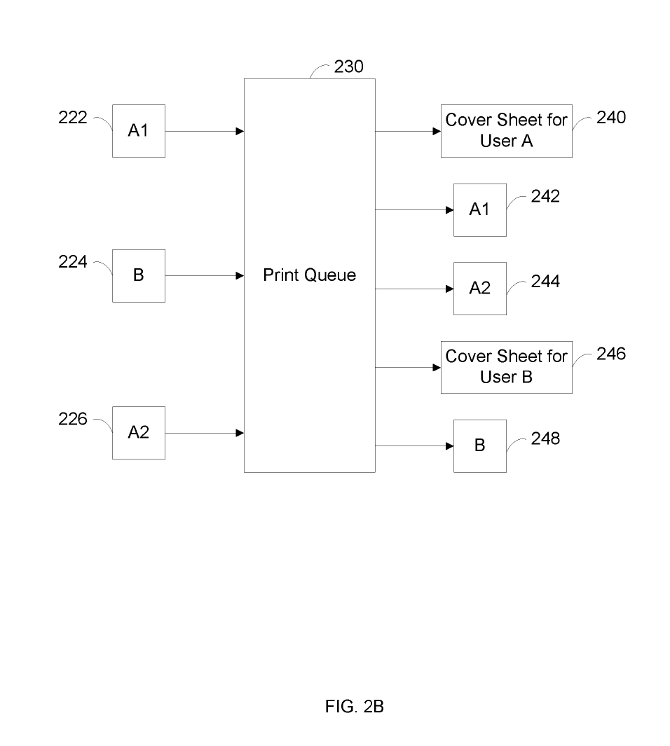

Referring to FIG. 2A, in an exemplary embodiment, the present invention includes a step 212 of bundling requests for printing a set of the documents from at least one user of at least one of the computer systems, where the bundling includes (a) delaying each of the requests by a certain amount of time and (b) reordering a print queue so that the documents from the user form a contiguous set of documents from the user, a step 214 of outputting one cover sheet from the printer for the contiguous set, and a step 216 of printing the contiguous set on the printer. In an exemplary embodiment, the certain amount of time is 5 minutes.

Referring to FIG. 2B, in an exemplary embodiment, when a print queue 230 receives a request 222 from a user A to print an electronic document A1, a request 224 from a user B to print an electronic document B, and a request 226 from user A to print an electronic document A2, in that order, print queue 230 outputs a cover sheet 240 (a cover sheet for user A), document 242 (document A1), document 244 (document A2), a cover sheet 246 (a cover sheet for user B), and, document 248 (document B), in that order.

Bundling

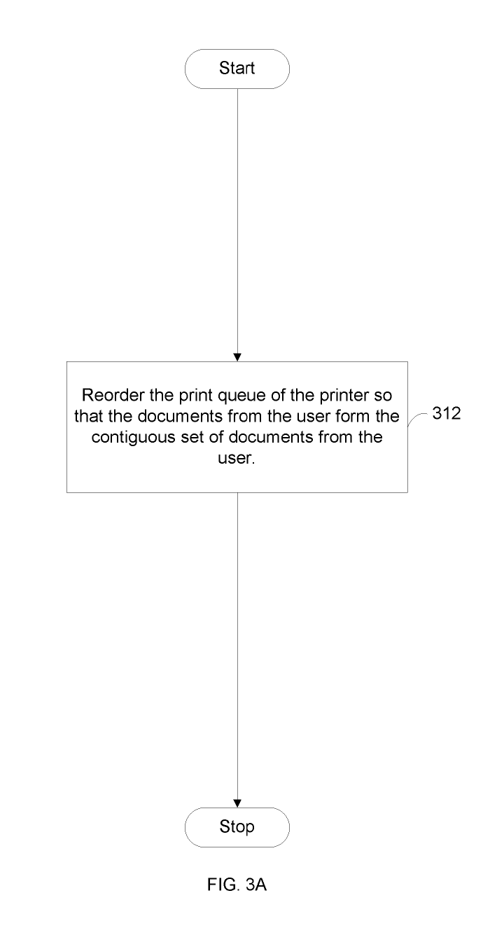

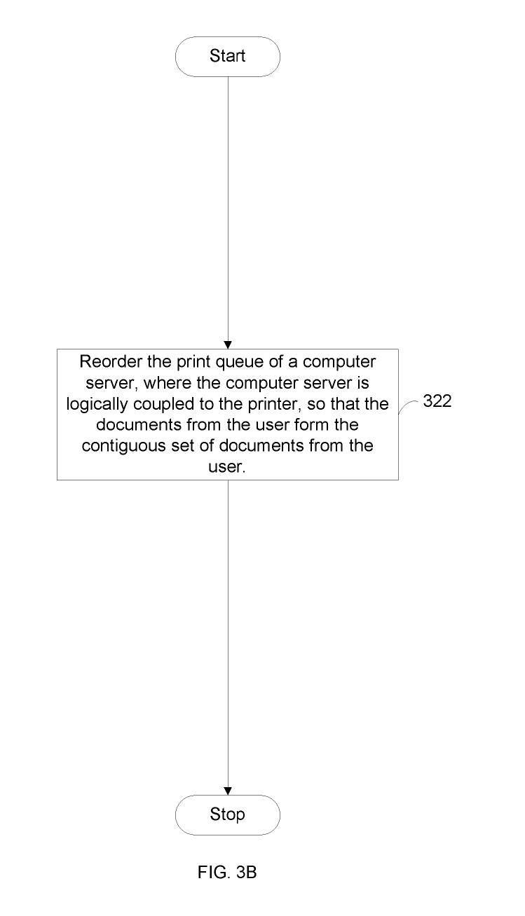

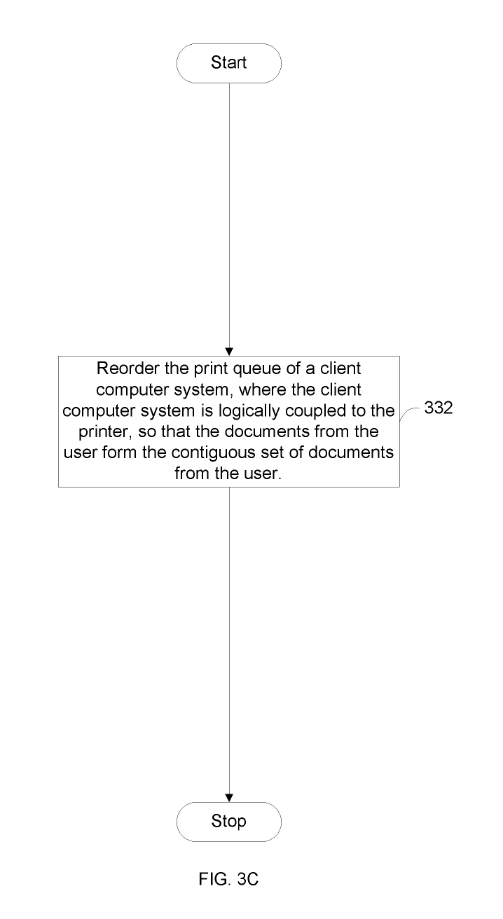

Referring to FIG. 3A, in an exemplary embodiment, bundling step 212 further includes a step 312 of reordering the print queue of the printer so that the documents from the user form the contiguous set of documents from the user. For example, the firmware of the printer could perform reordering step 312.

Referring to FIG. 3B, in an exemplary embodiment, bundling step 212 further includes a step 322 of reordering the print queue of a computer server, where the computer server is logically coupled to the printer, so that the documents from the user form the contiguous set of documents from the user. For example, the computer server could be a network print server, a computer that manages the print queue of the printer.

Referring to FIG. 3C, in an exemplary embodiment, bundling step 212 further includes a step 332 of reordering the print queue of a client computer system, where the client computer system is logically coupled to the printer, so that the documents from the user form the contiguous set of documents from the user.

### Lazy Printing

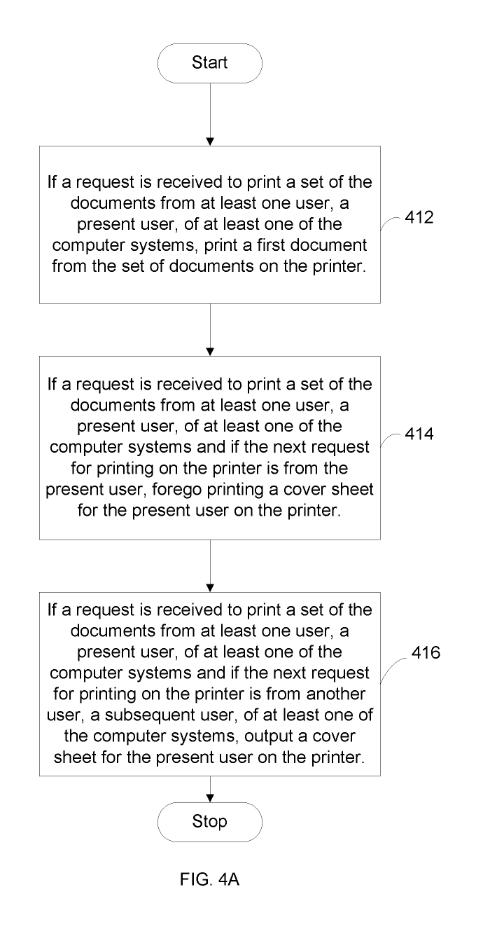

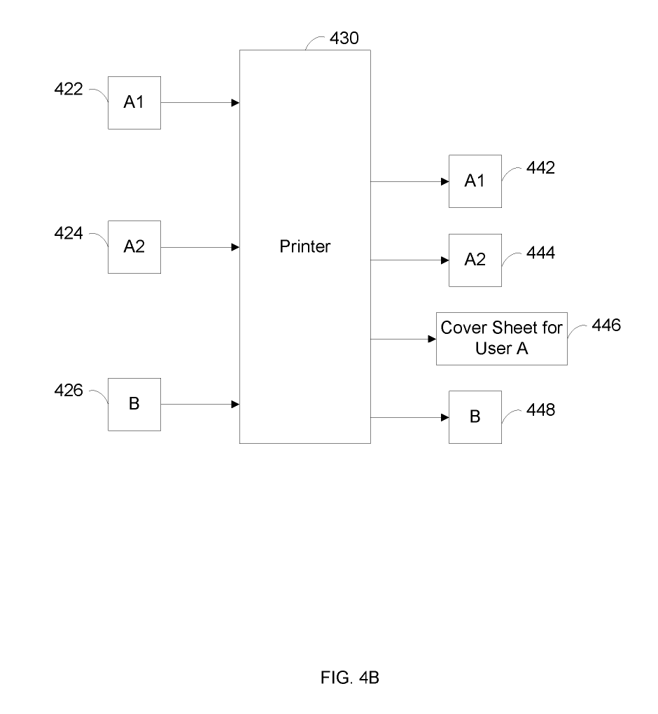

Referring to FIG. 4A, in an exemplary embodiment, the present invention includes, a step 412 of, if a request is received to print a set of the documents from at least one user, a present user, of at least one of the computer systems, printing a first document from the set of documents on the printer, a step 414 of, if a request is received to print a set of the documents from at least one user, a present user, of at least one of the computer systems and if the next request for printing on the printer is from the present user, foregoing printing a cover sheet for the present user on the printer, and a step 416 of, if a request is received to print a set of the documents from at least one user, a present user, of at least one of the computer systems and if the next request for printing on the printer is from another user, a subsequent user, of at least one of the computer systems, outputting a cover sheet for the present user on the printer.

Referring to FIG. 4B, in an exemplary embodiment, when a printer 430 receives a request 422 from a user A to print an electronic document A1, a request 424 from user A to print an electronic document A2, and a request 426 from a user B to print an electronic document B, in that order, printer 430 outputs a document 442 (document A1), document 444 (document A2), a cover sheet 446 (a cover sheet for user A), and document 448 (document B), in that order.

Foregoing

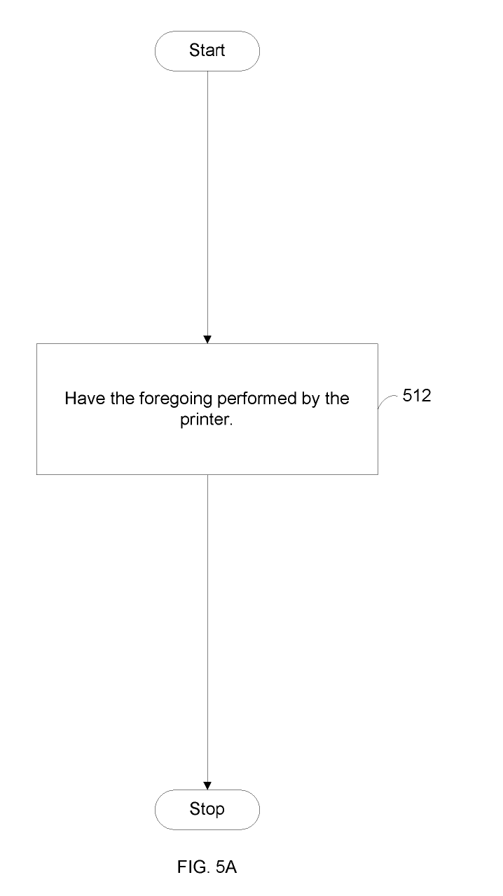

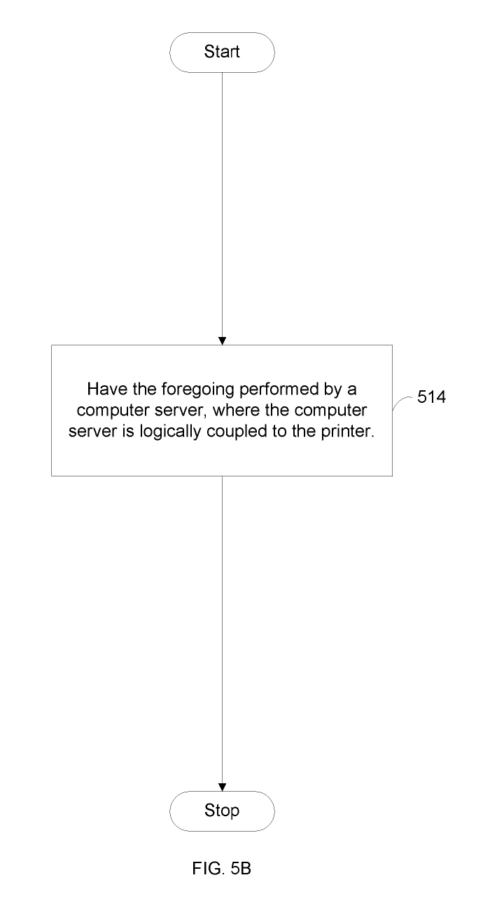

Referring to FIG. 5A, in an exemplary embodiment, foregoing step 414 includes a step 512 of having the foregoing performed by the printer. In other words, the printer could decide to forego printing a cover sheet for the present user on the printer. Also, the firmware of the printer could perform foregoing step 414. Referring to FIG. 5B, in an exemplary embodiment, foregoing step 414 includes a step 514 of having the foregoing performed by a computer server, where the computer server is logically coupled to the printer. Thus, the computer server could decide to forego printing a cover sheet for the present user on the printer. Also, the computer server could be a network print server, a computer that manages the print queue of the printer.

Outputting

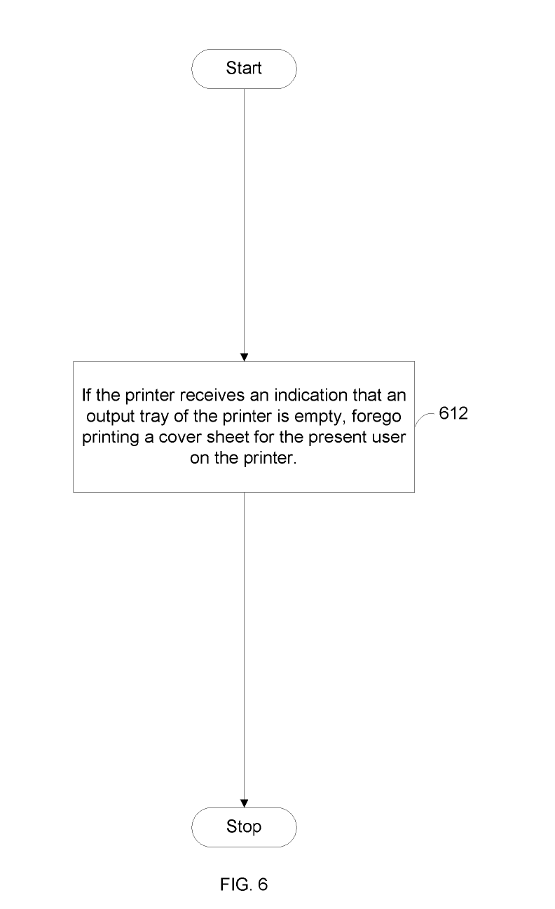

Referring to FIG. 6, in an exemplary embodiment, outputting step 416 includes a step 612 of, if the printer receives an indication that an output tray of the printer is empty, foregoing printing a cover sheet for the present user on the printer.

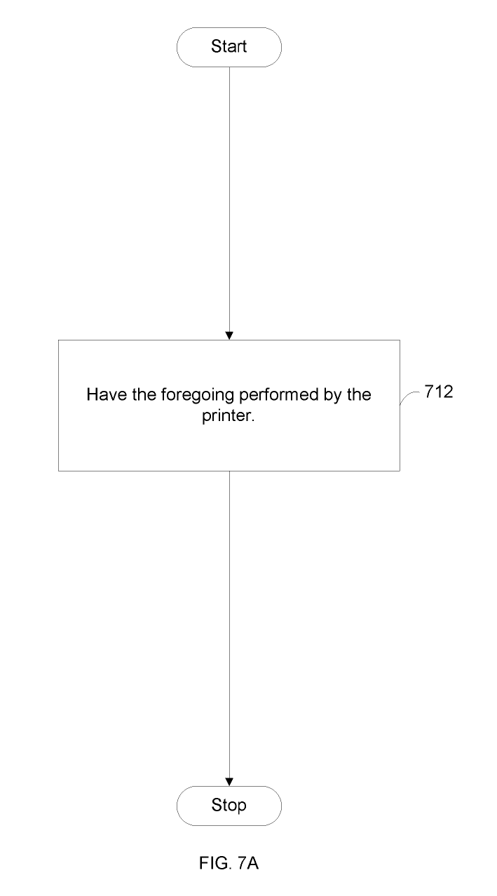

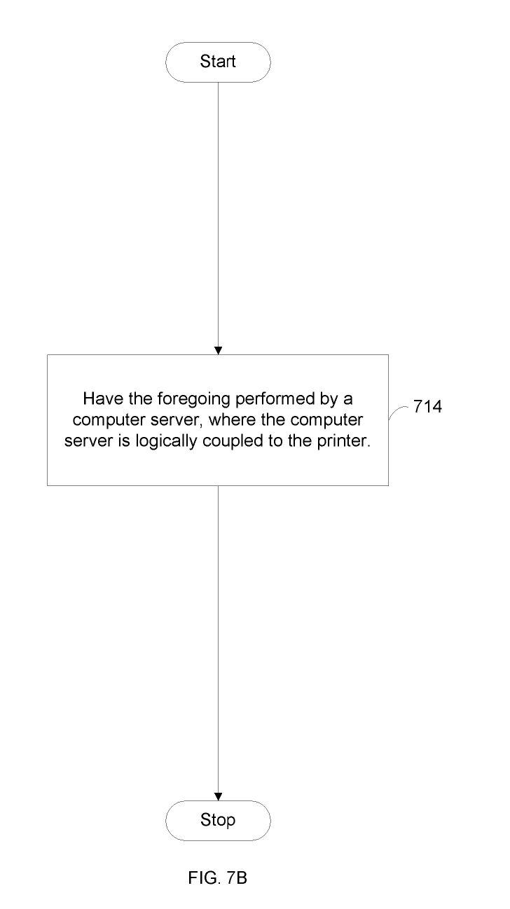

Referring to FIG. 7A, in an exemplary embodiment, foregoing step 612 includes a step 712 of having the foregoing performed by the printer. In other words, the printer could decide to forego printing a cover sheet for the present user on the printer. Also, the firmware of the printer could perform foregoing step 712. Referring to FIG. 7B, in an exemplary embodiment, foregoing step 612 includes a step 714 of having the foregoing performed by a computer server, where the computer server is logically coupled to the printer. In other words, the computer server could decide to forego printing a cover sheet for the present user on the printer. Also, the computer server could be a network print server, a computer that manages the print queue of the printer.

### Odd Printing

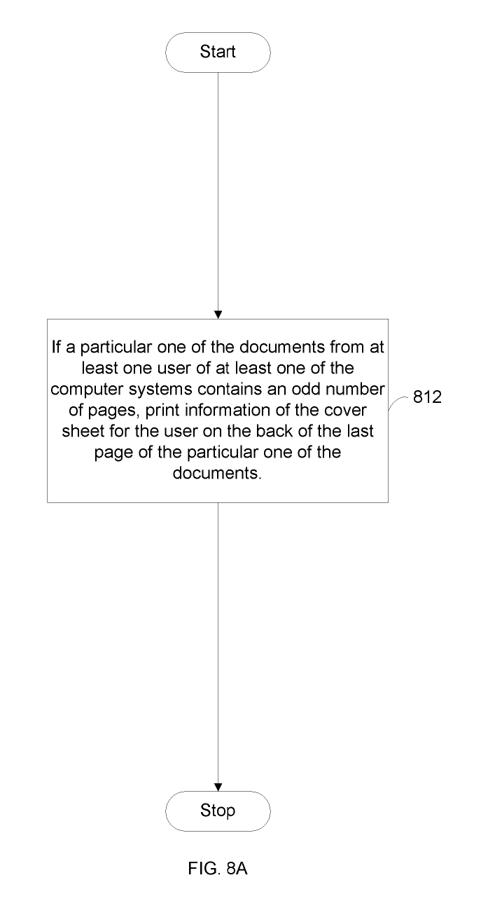

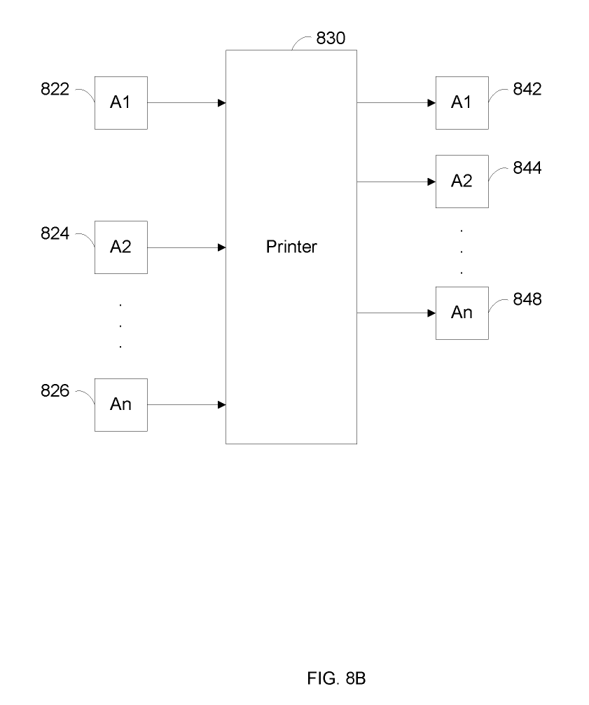

Referring to FIG. 8A, in an exemplary embodiment, the present invention includes, a step 812 of, if a particular one of the documents from at least one user of at least one of the computer systems contains an odd number of pages, printing information of the cover sheet for the user on the back of the last page of the particular one of the documents.

Referring to FIG. 8B, in an exemplary embodiment, when a printer 830 receives a request from a user A to print an electronic document that includes an odd number of pages, a page 822 (a page A1), a page 824 (a page A2), and a page 826 (a page An), where n is an odd number, in that order, printer 830 outputs the document as a page 842 (page A1), a page 844 (page A2), and a page 848 (page An) and prints information of the cover sheet for user A on the back of page 848.

### Blank Sheets

In an exemplary embodiment, the present invention includes, for each of the documents, outputting a blank sheet before printing the document on the printer. In an exemplary embodiment, the outputting includes outputting a blank sheet of paper before printing the document on the printer. In an exemplary embodiment, the outputting includes outputting a blank sheet of a durable material before printing the document on the printer. In an exemplary embodiment, the durable material is a plastic material.

### General

The present invention can take the form of an entirely hardware embodiment, an entirely software embodiment, or an embodiment containing both hardware and software elements. In an exemplary embodiment, the present invention is implemented in software, which includes but is not limited to firmware, resident software, and microcode.

Furthermore, the present invention can take the form of a computer program product accessible from a computer-usable or computer-readable medium providing program code for use by or in connection with a computer system or any instruction execution system. The computer program product includes the instructions that implement the method of the present invention. A computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

A computer system suitable for storing and/or executing program code includes at least one processor coupled directly or indirectly to memory elements through a system bus. The memory elements include local memory employed during actual execution of the program code, bulk storage, and cache memories that provide temporary storage of at least some program code to reduce the number of times code is retrieved from bulk storage during execution. Input/output (I/O) devices (including but not limited to keyboards, displays, pointing devices, etc.) can be coupled to the computer system either directly or through intervening I/O controllers. Network adapters may also be coupled to the computer system in order to enable the computer system to become coupled to other computer systems or remote printers or storage devices through intervening private or public networks. Modems, cable modems, and Ethernet cards are just a few of the currently available types of network adapters. The computer system can also include an operating system and a compute file-system.

### CONCLUSION

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

What is claimed is:

1. A processor-implemented method of printing a plurality of electronic documents on a computer printer, wherein the printer is logically coupled to a plurality of computer systems, the method comprising:
bundling requests for printing a set of the documents from at least one user of at least one of the computer systems, wherein the bundling comprises
delaying each of the requests by a certain amount of time and
reordering a print queue so that the documents from the user form a contiguous set of documents from the user;
outputting one cover sheet from the printer for the contiguous set; and
printing the contiguous set on the printer.

2. The method of claim 1 wherein the bundling further comprises reordering the print queue of the printer so that the documents from the user form the contiguous set of documents from the user.

3. The method of claim 1 wherein the bundling further comprises reordering the print queue of a computer server, wherein the computer server is logically coupled to the printer, so that the documents from the user form the contiguous set of documents from the user.

4. The method of claim 1 wherein the bundling further comprises reordering the print queue of a client computer system, wherein the client computer system is logically coupled to the printer, so that the documents from the user form the contiguous set of documents from the user.

5. A processor-implemented method of printing a plurality of electronic documents on a computer printer, wherein the printer is logically coupled to a plurality of computer systems, the method comprising:
if a request is received to print a set of the documents from at least one user, a present user, of at least one of the computer systems,
printing a first document from the set of documents on the printer,
if the next request for printing on the printer is from the present user, foregoing printing a cover sheet for the present user on the printer, and
if the next request for printing on the printer is from another user, a subsequent user, of at least one of the computer systems, outputting a cover sheet for the present user on the printer.

6. The method of claim 5 wherein the foregoing comprises having the foregoing performed by the printer.

7. The method of claim 5 wherein the foregoing comprises having the foregoing performed by a computer server, where the computer server is logically coupled to the printer.

8. The method of claim 5 wherein the outputting comprises, if the printer receives an indication that an output tray of the printer is empty, foregoing printing a cover sheet for the present user on the printer.

9. The method of claim 8 wherein the foregoing comprises having the foregoing performed by the printer.

10. The method of claim 8 wherein the foregoing comprises having the foregoing performed by a computer server, where the computer server is logically coupled to the printer.

11. A processor-implemented method of printing a plurality of electronic documents on a computer printer, wherein the printer is logically coupled to a plurality of computer systems, the method comprising:
if a particular one of the documents from at least one user of at least one of the computer systems contains an odd number of pages, printing information of the cover sheet for the user on the back of the last page of the particular one of the documents.

12. A processor-implemented system of printing a plurality of electronic documents on a computer printer, wherein the printer is logically coupled to a plurality of computer systems, the method comprising:
a bundling module configured to bundle requests for printing a set of the documents from at least one user of at least one of the computer systems, wherein the bundling module comprises
a delaying module configured to delay each of the requests by a certain amount of time and
a reordering module configured to reorder a print queue so that the documents from the user form a contiguous set of documents from the user;
an outputting module configured to output one cover sheet from the printer for the contiguous set; and
a printing module configured to print the contiguous set on the printer.

13. The system of claim 12 wherein the bundling module further comprises a reordering module configured to reorder the print queue of the printer so that the documents from the user form the contiguous set of documents from the user.

14. The system of claim 12 wherein the bundling module further comprises a reordering module configured to reorder the print queue of a computer server, wherein the computer server is logically coupled to the printer, so that the documents from the user form the contiguous set of documents from the user.

15. The system of claim 12 wherein the bundling module further comprises a reordering module configured to reorder the print queue of a client computer system, wherein the client computer system is logically coupled to the printer, so that the documents from the user form the contiguous set of documents from the user.

16. A computer program product usable with a programmable computer having readable program code embodied therein of printing a plurality of electronic documents on a computer printer, wherein the printer is logically coupled to a plurality of computer systems, the computer program product comprising:
computer readable code for bundling requests for printing a set of the documents from at least one user of at least one of the computer systems, wherein the computer readable code for bundling comprises
computer readable code for delaying each of the requests by a certain amount of time and
computer readable code for reordering a print queue so that the documents from the user form a contiguous set of documents from the user;
computer readable code for outputting one cover sheet from the printer for the contiguous set; and
computer readable code for printing the contiguous set on the printer.

17. The computer program product of claim 16 wherein the computer readable code for bundling further comprises computer readable code for reordering the print queue of the printer so that the documents from the user form the contiguous set of documents from the user.

18. The computer program product of claim 16 wherein the computer readable code for bundling further comprises computer readable code for reordering the print queue of a computer server, wherein the computer server is logically coupled to the printer, so that the documents from the user form the contiguous set of documents from the user.

19. The computer program product of claim 16 wherein the computer readable code for bundling further comprises computer readable code for reordering the print queue of a client computer system, wherein the client computer system is logically coupled to the printer, so that the documents from the user form the contiguous set of documents from the user.
